(19) United States
(12) Patent Application Publication
(10) Pub. No.: US 2023/0068572 A1
(43) Pub. Date: Mar. 2, 2023

(54) CHARGING/DISCHARGING MANAGEMENT SYSTEM

(71) Applicant: Prime Planet Energy & Solutions, Inc., Tokyo (JP)

(72) Inventors: Hiroshi TATSUMI, Kakogawa-shi (JP); Katsushi SAITO, Nagakute-shi (JP); Masato KOUTARI, Kakogawa-shi (JP); Kiyota TANIGUCHI, Hyogo-ken (JP); Miho SAISHO, Kobe-shi (JP); Yuki ITO, Kasugai-shi (JP); Aya SATO, Nagoya-shi (JP)

(21) Appl. No.: 17/891,133

(22) Filed: Aug. 19, 2022

(30) Foreign Application Priority Data
Aug. 24, 2021 (JP) 2021-135991

(51) Int. Cl. G06Q 50/06; B60L 53/62; B60L 53/63; B60L 53/66; B60L 58/12; G06Q 10/06; H02J 7/00

(52) U.S. Cl. CPC G06Q 50/06; B60L 53/62; B60L 53/63; B60L 53/66; B60L 58/12; G06Q 10/06315; H02J 7/00034; H02J 7/0048; H02J 7/0013; H02J 7/00712; G01C 21/3469

(57) ABSTRACT

The charging/discharging time of electric vehicle is shortened. The charging/discharging management system includes: a first acquisition controller configured to acquire vehicle information including vehicle capabilities regarding charging/discharging capabilities of multiple electric vehicles; a second acquisition controller configured to acquire device information including device capabilities regarding charging/discharging capabilities of multiple charging/discharging devices capable of charging/discharging the electric vehicles; and an assigning controller configured to compare the vehicle capabilities and assign the charging/discharging device having a high device capability among the charging/discharging devices for which device information has been acquired in the second acquisition controller, to the electric vehicle having a high vehicle capability.

### CROSS REFERENCE TO RELATED APPLICATIONS

The present application is based upon and claims the benefit of priority from Japanese patent application No. 2021-135991 filed on Aug. 24, 2021, and the entire disclosure of which is incorporated herein in its entirety by reference.

The present disclosure relates to a charging/discharging management system. The present disclosure specifically relates to a charging/discharging management system configured to manage charging/discharging of electric vehicles.

### BACKGROUND

For example, WO 2011/077780 discloses an electric power control system using battery electric vehicles. This electric power control system includes charging/discharging spots that are connected to an electric power system and charges/discharges battery electric vehicles, a data center, and a power aggregator.

The data center collects and stores current position information of battery electric vehicles and charging state information of storage batteries of the battery electric vehicles. The power aggregator creates a ranking list that ranks the degree of necessity for charging/discharging of each battery electric vehicle on the basis of the current position information of the battery electric vehicles, the charging state information, and the position information of the charging/discharging spots.

In this electric power control system, the power aggregator distributes information to guide the battery electric vehicle as to which charging/discharging spot the battery electric vehicle is charged or discharged according to the ranking list. This allows moving battery electric vehicle to be guided to the charging/discharging spot to secure electric power to be supplied to the electric power system.

For example, electric vehicles including battery electric vehicles may have different charging/discharging capabilities. Further, charging/discharging devices which charge/discharge the electric vehicles may have different charging/discharging capabilities. The electric power control system disclosed in WO 2011/077780 may guide an electric vehicle having a high charging/discharging capability to a charging/discharging device having a low charging/discharging capability, for example. If the electric vehicle having a high charging/discharging capability is connected to and charged/discharged by the charging/discharging device having a low charging/discharging capability, the electric vehicle is charged/discharged in accordance with the charging/discharging time of the charging/discharging device having a low charging/discharging capability. Accordingly, the charging/discharging time for the electric vehicle having a high charging/discharging capability is increased even through the electric vehicle has a high charging/discharging capability. This charging/discharging time is suitably as short as possible.

### SUMMARY

The charging/discharging management system proposed herein includes a first acquisition controller, a second acquisition controller, and an assigning controller. The first acquisition controller is configured or programmed to acquire vehicle information including vehicle capabilities regarding charging/discharging capabilities of multiple electric vehicles. The second acquisition controller is configured or programmed to acquire device information including device capabilities regarding charging/discharging capabilities of multiple charging/discharging devices capable of charging/discharging the electric vehicles. The assigning controller is configured or programmed to compare the vehicle capabilities and assign the charging/discharging device having a high device capability among the charging/discharging devices for which the device information has been acquired in the second acquisition controller, to the electric vehicle having a high vehicle capability.

In the charging/discharging management system proposed herein, the assigning controller assigns the charging/discharging device having a high device capability to an electric vehicle having a high vehicle capability. This allows a high vehicle capability to be exhibited. Accordingly, the charging/discharging time for the electric vehicle having a high vehicle capability can be shortened.

In the charging/discharging management system proposed herein, the second acquisition controller may at least be configured or programmed to acquire the device information of a first charging/discharging device and the device information of a second charging/discharging device having a lower device capability than the first charging/discharging device. The charging/discharging management system may further include a communication controller and a determination controller. The communication controller may be configured or programmed to receive charging/discharging signals which have been transmitted by the users using the electric vehicles. The determination controller may be configured or programmed to determine whether or not the vehicle capabilities of the electric vehicles used by the users who have transmitted the charging/discharging signals are equal to or higher than a predetermined reference capability. The assigning controller may be configured or programmed to assign the first charging/discharging device as a charging/discharging destination if the determination controller determines that the vehicle capability of the electric vehicle is equal to or higher than the reference ability, and assign the second charging/discharging device as a charging/discharging destination if the determination controller determines that the vehicle capability of the electric vehicle is lower than the reference ability. The charging/discharging management system may further include a presentation controller configured or programmed to present, to the user, the charging/discharging device which has been assigned by the assigning controller.

In the charging/discharging management system proposed herein, the communication controller may be configured or programmed to receive charging/discharging signals which have been transmitted by the users using the electric vehicles during a predetermined period of time. The assigning controller may be configured or programmed to assign the charging/discharging devices to the respective electric vehicles so that differences of the vehicle capabilities of the electric vehicles from the device capabilities become small.

The charging/discharging management system proposed herein may further include a calculation controller configured or programmed to calculate a distance from the electric vehicles to the first charging/discharging device, and a distance determination controller configured or programmed to determine whether or not the distance calculated by the calculation controller is shorter than a predetermined reference distance. The assigning controller may be configured or programmed to assign the first charging/discharging device as a charging/discharging destination if the determination controller determines that the vehicle capability of the electric vehicle is equal to or higher than the reference ability, and the distance determination controller determines that the distance is shorter than the reference distance.

In the charging/discharging management system proposed herein, the vehicle information acquired by the first acquisition controller may include battery states of batteries mounted on the electric vehicles. The assigning controller may be configured or programmed to assign the charging/discharging devices to the respective electric vehicles on the basis of the battery states. Each of the battery states may include at least charge SOC. The charging/discharging management system may further include a state determination controller configured or programmed to determine whether or not the charge SOC is smaller than a predetermined reference SOC. The assigning controller may be configured or programmed to assign the first charging/discharging device if the state determination controller determines that the charge SOC is smaller than the reference SOC.

In the charging/discharging management system proposed herein, each of the vehicle capabilities and the device capabilities may be a charging/discharging rate.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a conceptual diagram illustrating a charging/discharging management system according to an embodiment.

FIG. 2 is a block diagram illustrating the charging/discharging management system according to the embodiment.

FIG. 3 is a flowchart illustrating procedures of assigning a charging/discharging device to an electric vehicle.

FIG. 4 is a conceptual diagram illustrating examples of electric vehicles and charging/discharging devices assigned to the electric vehicles.

FIG. 5 is a flowchart illustrating procedures of assigning a charging/discharging device to an electric vehicle according to a charging/discharging capability.

FIG. 6 is a flowchart illustrating procedures of assigning a charging/discharging device to an electric vehicle according to a distance to the charging/discharging device and the charging/discharging capability.

FIG. 7A is a graph illustrating a relationship between a battery temperature and a vehicle capability.

FIG. 7B is a graph illustrating a relationship between a battery temperature and a vehicle capability according to a degradation state of a battery.

FIG. 7C is a graph illustrating a relationship between charge SOC and a vehicle capability.

FIG. 8 is a flowchart illustrating procedures of assigning a charging/discharging device to an electric vehicle according to charge SOC.

### DETAILED DESCRIPTION

The following describes an embodiment of the charging/discharging management system disclosed herein with reference to drawings. The embodiment described herein is naturally not intended to limit the present disclosure. Unless specifically mentioned, the present disclosure is not limited to the embodiment described herein. The same members/portions which exhibit the same action are denoted by the same reference numerals, and the duplicated descriptions are omitted.

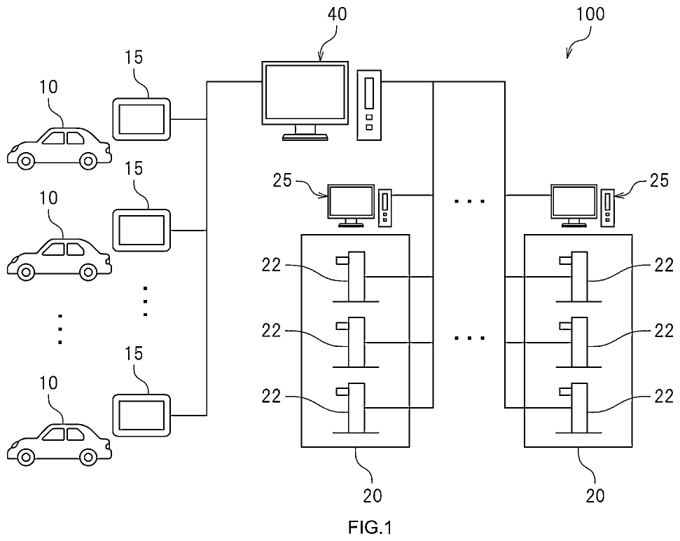

FIG. 1 is a conceptual diagram illustrating a charging/discharging management system 100 according to the present embodiment. The charging/discharging management system 100 according to the present embodiment is a system configured or programmed to manage charging or discharging (here also referred to as charging/discharging) of electric vehicles 10. Although not shown in the drawing, this charging/discharging management system 100 includes a power storage device storing electric power. The charging/discharging management system 100 manages charging of the electric vehicles 10 with the electric power stored in the power storage device and storing of the electric power discharged from the electric vehicles 10 in the power storage device. The electric power stored in the power storage device can be sold to certain vendors, such as electric power companies. The charging/discharging management system 100 may be a system used for buying and selling electric power.

A person who manages the charging/discharging management system 100 is referred to here as a system manager. The system manager is also referred to as an aggregator. The system manager controls the amount of electric power demanded to maintain a balance between supply a demand of electric power. For example, the system manager procures electric power according to the demand of a particular vendor such as an electric power company, and supplies the electric power to the particular vendor. It is thus suitable for the system manager to contract more users of the electric vehicles 10 and more managers managing the charging/discharging devices 22 by using the charging/discharging management system 100 in order to secure the required amount of electric power. For example, in the charging/discharging management system 100, one or more users who use or own the electric vehicles 10 are registered, and one or more managers who manage the charging/discharging devices 22 that charge/discharge the electric vehicles 10 are registered. In the charging/discharging management system 100, the electric vehicles 10 themselves and the charging/discharging devices 22 themselves may be registered. The charging/discharging management system 100 supplies (here, charges) electric power from the charging/discharging devices 22 to the electric vehicles 10, or supplies (here, discharges) electric power from the electric vehicles 10 to the charging/discharging devices 22 to manage electric power.

In the present embodiment, the electric vehicles 10 include vehicles that use electric power as an energy source such as battery electric vehicles, hybrid electric vehicles, and plug-in hybrid electric vehicles. Each electric vehicle 10 may be a four-wheeled vehicle or a two-wheeled vehicle. Here, the one or more charging/discharging devices 22 are installed at a charging/discharging spot 20. The number of the charging/discharging devices 22 installed at one charging/discharging spot 20 is not particularly limited. The charging/discharging spot 20 can be a parking lot where the charging/discharging devices 22 have been installed. The parking lot includes parking lots for stores that sell merchandise, parking lots for stores that provide services such as beauty salons, parking lots for commercial facilities, and parking lots for residential buildings.

Each electric vehicle 10 may have a different charging/discharging capability. Further, each charging/discharging device 22 may have a different charging/discharging capability. The charging/discharging capability of the electric vehicle 10 here refers to the vehicle capability. The vehicle capability relates to the charging/discharging capability of the electric vehicle 10. The charging/discharging capability of the charging/discharging device 22 is referred to as a device capability. The device capability relates to the charging/discharging capability of each charging/discharging device 22. In the present embodiment, each of the vehicle capability and the device capability is a charging/discharging rate. For example, a high charging/discharging capability (here, a high vehicle capability or a high device capability) means a high charging/discharging rate, and a low charging/discharging capability means a low charging/discharging rate. For example, if the electric vehicle 10 having a high vehicle capability performs charging/discharging by the charging/discharging device 22 having a low device capability, the charging/discharging time is increased even through the vehicle capability is high. The charging/discharging time is suitably as short as possible.

In the present embodiment, the charging/discharging management system 100 achieves assigning of the charging/discharging devices 22 to the electric vehicles 10 on the basis of the vehicle capabilities of the electric vehicles 10 and the device capabilities of the charging/discharging devices 22 so that the charging/discharging time is shortened.

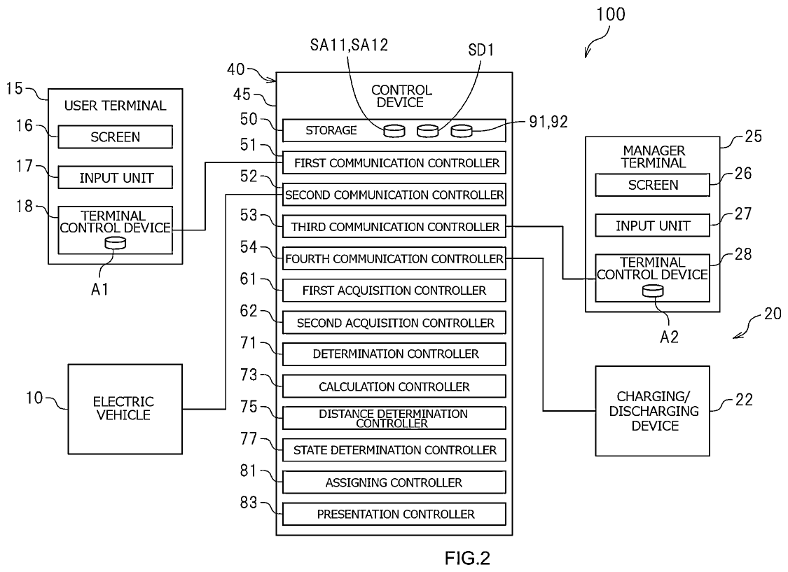

Next, the configuration of the charging/discharging management system 100 according to the present embodiment will be described. The charging/discharging management system 100 is realized, for example, by a client server system. The charging/discharging management system 100 may be realized by cloud computing. FIG. 2 is a block diagram illustrating the charging/discharging management system 100. As illustrated in FIG. 2, the charging/discharging management system 100 includes a user terminal 15, a manager terminal 25, and a management server 40.

The user terminal 15 is a terminal used by the user who uses the electric vehicle 10. Here, the user terminal 15 may be, for example, a car navigation system mounted on the electric vehicle 10, or a smartphone, tablet terminal, or desktop or laptop personal computer used by the user. The user terminal 15 includes a screen 16, an input unit 17 for inputting by operation of the user, such as a touch panel, a keyboard, or a mouse, and a terminal control device 18. The terminal control device 18 is communicatively connected to the screen 16 and the input unit 17.

The manager terminal 25 is a terminal used by a manager of the charging/discharging spot 20. The manager terminal 25 may be a desktop or laptop personal computer, a smartphone, or a tablet terminal, used by the manager, for example. The manager terminal 25 includes a screen 26, an input unit 27 for inputting by operation of the manager terminal 25, such as a keyboard, a mouse, or a touch panel, and a terminal control device 28. The terminal control device 28 is communicatively connected to the screen 26 and the input unit 27.

The management server 40 is communicatively connected to the user terminal 15 and the manager terminal 25. The management server 40 may be communicatively connected to the electric vehicle 10 used by the user and the charging/discharging device 22 installed at the charging/discharging spot 20. The management server 40 may be realized by a single computer or by multiple computers working together. The management server 40 includes a control device 45. Although not shown in the drawing, the management server 40 may include a screen and an input unit as in the user terminal 15.

The control device 45 is configured or programmed to manage charging or discharging of electric vehicles 10. The configuration of the control device 45 is not particularly limited. The control device 45 here is, for example, a microcomputer. The control device 45 includes, for example, I/F, CPU, ROM, and RAM. As shown in FIG. 2, the control device 45 includes a storage 50, a first communication controller 51, a second communication controller 52, a third communication controller 53, and a fourth communication controller 54. The control device 45 further includes a first acquisition controller 61, a second acquisition controller 62, a determination controller 71, a calculation controller 73, a distance determination controller 75, state determination controller 77, an assigning controller 81, and a presentation controller 83. The units 50 to 83 constituting the control device 45 may be realized by one or more processors or may be incorporated into a circuit.

The first communication controller 51 is configured or programmed to be communicative to the user terminal 15 of the user using the electric vehicle 10. The first communication controller 51 is communicatively connected to the terminal control device 18 of the user terminal 15. In present embodiment, the first communication controller 51 is an example of the communication controller of the present disclosure. The second communication controller 52 is configured or programmed to be communicative to the electric vehicle 10 used by the user. The third communication controller 53 is configured or programmed to be communicative to the manager terminal 25 of the manager of the charging/discharging spot 20. The third communication controller 53 here is communicatively connected to the terminal control device 28 of the manager terminal 25. The fourth communication controller 54 is configured or programmed to be communicative to the charging/discharging device 22 installed at the charging/discharging spot 20.

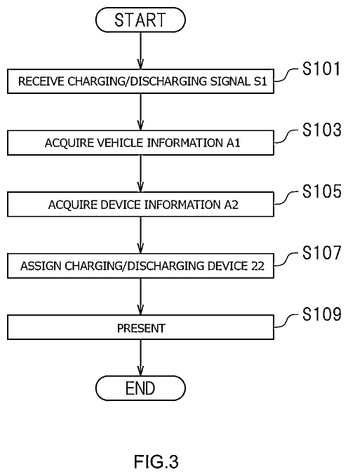

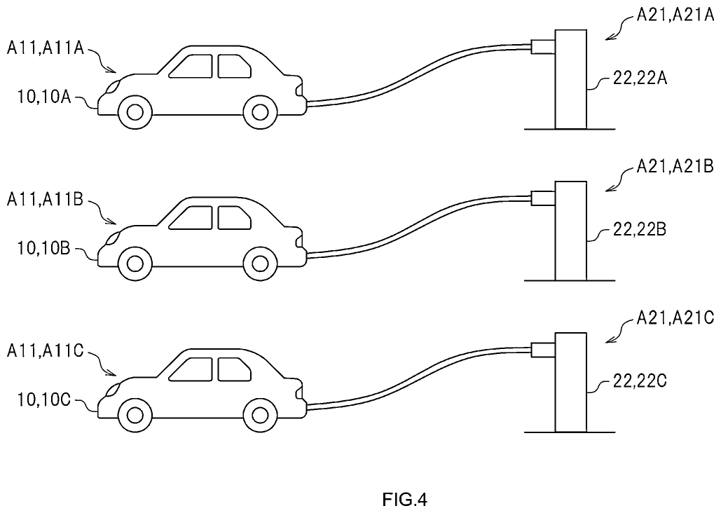

Next, the procedures for assigning the charging/discharging devices 22 to the respective electric vehicles 10 according to the vehicle capabilities and the device capabilities will be described with reference to the flowchart of FIG. 3. FIG. 4 is a conceptual diagram illustrating examples of electric vehicles 10 and charging/discharging devices 22 assigned to the electric vehicles 10. For the ease of understanding, procedures of assigning the electric vehicles 10 to the charging/discharging devices 22 so that the charging/discharging time is shortened in a case where the number of electric vehicles 10 is three and the number of charging/discharging devices 22 is three as shown in FIG. 4 will be described.

As shown in FIG. 4, the electric vehicles 10 include a first electric vehicle 10A, a second electric vehicle 10B, and a third electric vehicle 10C. Here, the charging/discharging capability of the first electric vehicle 10A is a first vehicle capability A11A. The charging/discharging capability of the second electric vehicle 10B is a second vehicle capability A11B. The charging/discharging capability of the third electric vehicle 10C is a third vehicle capability A11C. The second vehicle capability A11B has a lower charging/discharging capability than the first vehicle capability A11A. The third vehicle capability A11C has a lower charging/discharging capability than the first vehicle capability A11A and the second vehicle capability A11B. In other words, the first electric vehicle 10A has the highest charging/discharging capability, followed by the second electric vehicle 10B.

The charging/discharging devices 22 include a first charging/discharging device 22A, a second charging/discharging device 22B, and a third charging/discharging device 22C. Here, the charging/discharging capability of the first charging/discharging device 22A is a first device capability A21A. The charging/discharging capability of the second charging/discharging device 22B is a second device capability A21B. The charging/discharging capability of the third charging/discharging device 22C is a third device capability A21C. The second device capability A21B has a lower charging/discharging capability than the first device capability A21A. The third device capability A21C has a lower charging/discharging capability than the first device capability A21A and the second device capability A21B. In other words, the first charging/discharging device 22A has the highest charging/discharging capability, followed by the second charging/discharging device 22B.

In the present embodiment, the first communication controller 51 of FIG. 2 is configured or programmed to receive a charging/discharging signal S1 which has transmitted from the user using the electric vehicle 10 in step S101 of FIG. 3. The charging/discharging signal S1 is a signal to inform that the user wishes to charge/discharge the electric vehicle 10 used by the user. A specific means by which the user transmits the charging/discharging signal S1 is not particularly limited. For example, the user may operate the input unit 17 (see FIG. 2) of the user terminal 15 to transmit the charging/discharging signal S1 from the user terminal 15 to the management server 40.

Here, the first communication controller 51 receives charging/discharging signals S1 which has been transmitted by multiple users during a predetermined period of time. The electric vehicles 10 used by the users who have transmitted the charging/discharging signals S1 during a predetermined period of time are vehicles to which the charging/discharging devices 22 are assigned. In the present embodiment, during the predetermined period of time, the charging/discharging signals S1 are transmitted to the management server 40 via the user terminal 15 from the users using the first electric vehicle 10A, the second electric vehicle 10B, and the third electric vehicle 10C, and the first communication controller 51 receives the charging/discharging signals S1 from the respective users.

Subsequently, in step S103 of FIG. 3, the first acquisition controller 61 of FIG. 2 acquires vehicle information A1 of multiple electric vehicles 10. Here, the electric vehicles 10 are electric vehicles 10 of the users who have transmitted the charging/discharging signals S1 which have received in the first communication controller 51, and include a first electric vehicle 10A to a third electric vehicle 10C of FIG. 4. In the present embodiment, the vehicle information A1 at least includes a vehicle capability A11 (see FIG. 4). The vehicle information A1 may include information relating to the electric vehicles 10 besides the vehicle capability A11.

In the present embodiment, as shown in FIG. 2, the vehicle information A1 is stored in the terminal control device 18 of the user terminal 15, for example. The first acquisition controller 61 is configured or programmed to acquire the vehicle information A1 from the terminal control device 18 of the user terminal 15 via the first communication controller 51. However, the vehicle information A1 may be stored in the electric vehicles 10 themselves. In this case, the first acquisition controller 61 may be configured or programmed to acquire the vehicle information A1 from the electric vehicles 10 via the second communication controller 52. The vehicle information A1 which has acquired by the first acquisition controller 61 is stored in the storage 50.

Subsequently, in step S105 of FIG. 3, the second acquisition controller 62 of FIG. 2 acquires device information A2 of the charging/discharging devices 22 capable of performing charging/discharging of the electric vehicles 10. Here, “the charging/discharging device 22 capable of performing charging/discharging of the electric vehicle 10” refers to the charging/discharging device 22 not in connection to the other electric vehicles 10, i.e., not in use among charging/discharging devices 22 which have installed within the predetermined distance from the electric vehicles 10 for which the vehicle information A1 has been acquired. Here, the first charging/discharging device 22A to the third charging/discharging device 22C of FIG. 4 are not in connection to the other electric vehicles 10. Thus, the second acquisition controller 62 acquires device information A2 of the first charging/discharging device 22A to the third charging/discharging device 22C.

The device information A2 at least includes the device capability A21 (see FIG. 4). Note that the device information A2 may further include information besides the device capability A21, and may further include, for example, information on whether or not the charging/discharging devices 22 are in use.

In the present embodiment, as shown in FIG. 2, the device information A2 is stored in the terminal control device 28 of the manager terminal 25. The second acquisition controller 62 may be configured or programmed to acquire the device information A2 from the terminal control device 28 of the manager terminal 25 via the third communication controller 53. However, the device information A2 may be stored in the charging/discharging devices 22 themselves. In this case, the second acquisition controller 62 may be configured or programmed to acquire the device information A2 from the charging/discharging devices 22 via the fourth communication controller 54. The device information A2 acquired by the second acquisition controller 62 is stored in the storage 50.

As described above, after acquisition of the vehicle information A1 and the device information A2, the assigning controller 81 assigns a charging/discharging device 22 to an electric vehicle 10 in step S107 of FIG. 3. Here, the assigning controller 81 is configured or programmed to determine which of the charging/discharging devices 22 (here, the first charging/discharging device 22A to the third charging/discharging device 22C) capable of performing charging/discharging is assigned to the electric vehicles 10 (here the first electric vehicle 10A to the third electric vehicle 10C) which have transmitted the charging/discharging signals S1.

In this embodiment, the assigning controller 81 is configured or programmed to compare the vehicle capabilities A11 and assign the charging/discharging device 22 having a high device capability A21 among the charging/discharging devices 22 for which the device information A2 has been acquired in the second acquisition controller 62, to the electric vehicle 10 having a high vehicle capability A11. The assigning controller 81 is configured or programmed to assign the charging/discharging devices 22 to the respective electric vehicles 10 so that a difference of the vehicle capability A11 of each of the of electric vehicles 10 from the device capability A21 of each of the charging/discharging devices 22 becomes small.

In the example of FIG. 4, among the first electric vehicle 10A to the third electric vehicle 10C, the first electric vehicle 10A, the second electric vehicle 10B, and the third electric vehicle 10C have higher vehicle capability A11 in order. Further, among the first charging/discharging device 22A to the third charging/discharging device 22C, the first charging/discharging device 22A, the second charging/discharging device 22B, and the third charging/discharging device 22C have a higher device capability A21 in order. Therefore, the assigning controller 81 assigns the first charging/discharging device 22A having the first device capability A21A which is the highest to the first electric vehicle 10A having the first vehicle capability A11A which is the highest. The assigning controller 81 assigns the second charging/discharging device 22B having the second device capability A21B which is the second highest to the second electric vehicle 10B having the second vehicle capability A11B which is the second highest. The assigning controller 81 assigns the third charging/discharging device 22C having the third device capability A21C which is the lowest to the third electric vehicle 10C having the third vehicle capability A11C which is the lowest.

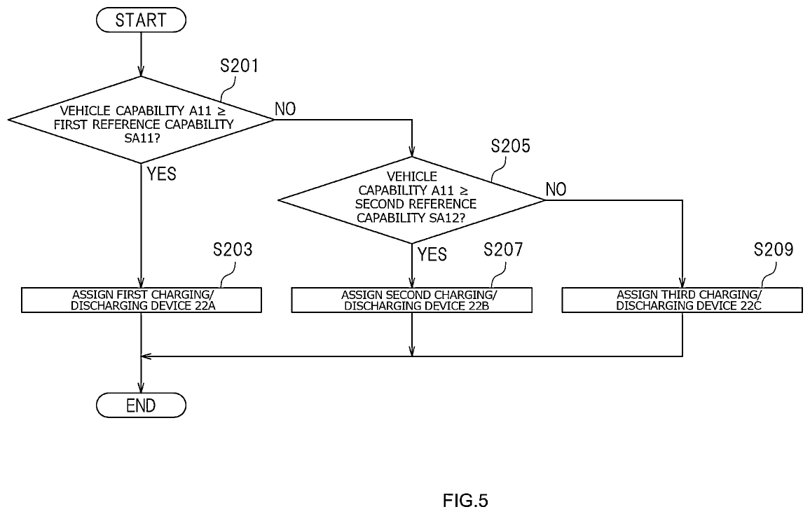

For example, the charging/discharging device 22 is assigned to the electric vehicle 10 according to the flowchart shown in FIG. 5. As shown in FIG. 2, the storage 50 stores, for example, a first reference ability SA11 and a second reference ability SA12. The first reference ability SA11 is higher than the second reference ability SA12. Here, in step S201 of FIG. 5, the determination controller 71 of FIG. 2 determines whether or not the vehicle capability A11 of the electric vehicle 10 is equal to or higher than the predetermined first reference ability SA11. If the determination controller 71 determines that the vehicle capability A11 is equal to or higher than the first reference ability SA11, the process proceeds to step S203 of FIG. 5. In step S203, the assigning controller 81 of FIG. 2 assigns the first charging/discharging device 22A as a charging/discharging destination of the electric vehicle 10. On the other hand, if the determination controller 71 determines that the vehicle capability A11 is less than the first reference ability SA11 in step S201, the process proceeds to step S205. In step S205, the determination controller 71 of FIG. 2 determines whether or not the vehicle capability A11 of the electric vehicle 10 is equal to or higher than the predetermined second reference ability SA12. If the determination controller 71 determines that the vehicle capability A11 is equal to or higher than the second reference ability SA12, the process proceeds to step S207 of FIG. 5. In step S207, the assigning controller 81 assigns the second charging/discharging device 22B as a charging/discharging destination of the electric vehicle 10. On the other hand, if the determination controller 71 determines that the vehicle capability A11 is less than the second reference ability SA12 in step S205, the process proceeds to step S209. In step S209, the assigning controller 81 assigns the third charging/discharging device 22C as a charging/discharging destination of the electric vehicle 10.

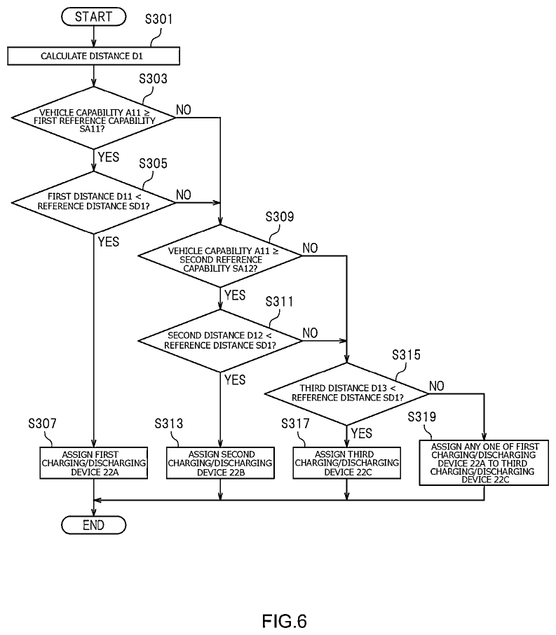

In the present embodiment, the charging/discharging device 22 may be assigned according to the distance from the electric vehicle 10 to the charging/discharging device 22. FIG. 6 is a flowchart illustrating procedures of assigning a charging/discharging device 22 to an electric vehicle 10 according to a distance D1 to the charging/discharging device 22 and the charging/discharging capability. First, in step S301 of FIG. 6, the calculation controller 73 of FIG. 2 calculates the distance D1 from the electric vehicle 10 to the charging/discharging device 22. Here, for example, the vehicle information A1 includes current position information of the electric vehicle 10, and the device information A2 includes position information of the charging/discharging device 22. The calculation controller 73 is configured or programmed to calculate the distance D1 on the basis of the current position information of the electric vehicle 10 and the position information of the charging/discharging device 22. Here, for one electric vehicle 10, the first distance D11 which is the distance D1 from the electric vehicle 10 to the first charging/discharging device 22A, the second distance D12 which is the distance D1 from the electric vehicle 10 to the second charging/discharging device 22B, and the third distance D13 which is the distance D1 from the electric vehicle 10 to the third charging/discharging device 22C are calculated.

Subsequently, in step S303 of FIG. 6, the determination controller 71 of FIG. 2 determines whether or not the vehicle capability A11 is equal to or higher than the first reference ability SA11. If the determination controller 71 determines that the vehicle capability A11 is equal to or higher than the predetermined first reference ability SA11, the distance determination controller 75 of FIG. 2 determines whether or not the first distance D11 is shorter than a reference distance SD1 in step S305. Here, the reference distance SD1 is a predetermined value, and stored in the storage 50 as shown in FIG. 2. If the distance determination controller 75 determines that the first distance D11 is shorter than the reference distance SD1 in step S305 of FIG. 6, the assigning controller 81 of FIG. 2 assigns the first charging/discharging device 22A as a charging/discharging destination of the electric vehicle 10 in subsequent step S307. If the determination controller 71 determines that the vehicle capability A11 is less than the first reference ability SA11 in step S303, or the distance determination controller 75 determines that the first distance D11 is equal to or higher than the reference distance SD1 in step S305, the process proceeds to step S309 of FIG. 6.

In step S309, the determination controller 71 of FIG. 2 determines whether or not the vehicle capability A11 is equal to or higher than the second reference ability SA12. If the determination controller 71 determines that the vehicle capability A11 is equal to or higher than the second reference ability SA12, the distance determination controller 75 of FIG. 2 determines whether or not the second distance D12 is shorter than the reference distance SD1 in step S311. If the distance determination controller 75 determines that the second distance D12 is shorter than the reference distance SD1, the assigning controller 81 of FIG. 2 assigns the second charging/discharging device 22B as a charging/discharging destination of the electric vehicle 10 in subsequent step S313. If the determination controller 71 determines that the vehicle capability A11 is less than the second reference ability SA12 in step S309, or the distance determination controller 75 determines that the second distance D12 is equal to or higher than the reference distance SD1 in step S311, the process proceeds to step S315.

In step S315, the distance determination controller 75 of FIG. 2 determines whether or not the third distance D13 is shorter than the reference distance SD1. If the distance determination controller 75 determines that the third distance D13 is shorter than the reference distance SD1, the assigning controller 81 of FIG. 2 assigns the third charging/discharging device 22C as a charging/discharging destination of the electric vehicle 10 in subsequent step S317. On the other hand, if the distance determination controller 75 determines that the third distance D13 is equal to or higher than the reference distance SD1 in step S315, the process proceeds to subsequent step S319. In step S319, the distance D1 to the first charging/discharging device 22A to the third charging/discharging device 22C is far. In this case, there is no particular limitation to which of the charging/discharging devices 22 is assigned, and for example, any of the first charging/discharging device 22A to the third charging/discharging device 22C is assigned according to the flowchart of FIG. 5.

In the present embodiment, the vehicle capability A11 can be calculated from the state (hereinafter referred to as the battery state) of the battery (e.g., a lithium ion secondary battery) mounted on the electric vehicle 10. Thus, the vehicle information A1 may include the battery state as the vehicle capability A11. The assigning controller 81 may be configured or programmed to assign the charging/discharging device 22 to the electric vehicle 10 on the basis of the battery state.

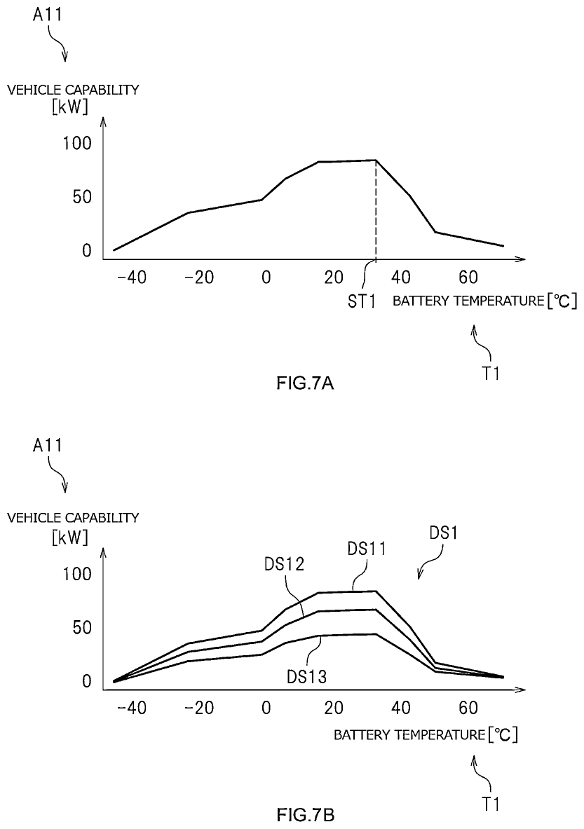

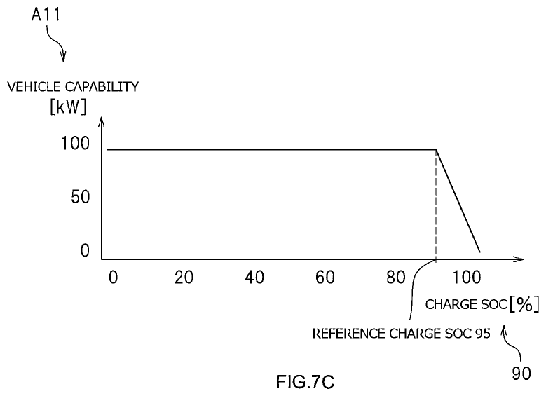

FIG. 7A is a graph illustrating a relationship between a battery temperature T1 and a vehicle capability A11. FIG. 7B is a graph illustrating a relationship between a battery temperature T1 and a vehicle capability A11 according to a degradation state DS1 of a battery. FIG. 7C is a graph illustrating a relationship between charge SOC 90 and a vehicle capability A11. In the present embodiment, the battery state includes the battery temperature T1 (see FIG. 7A), the degradation state DS1 of the battery state (see FIG. 7B), and the charge SOC 90 (see FIG. 7C). Here, as shown in FIG. 7A, the lower than battery temperature T1 is, the lower the vehicle capability A11 is. On the other hand, if the battery temperature T1 is excessively high, the degradation of the battery may be accelerated. Thus, the higher than battery temperature T1 is, the lower the vehicle capability A11 is. Here, the battery temperature T1 at the highest vehicle capability A11 is the reference temperature ST1. As the battery temperature T1 decreases from the reference temperature ST1, the vehicle capability A11 decreases. As the battery temperature T1 increases from the reference temperature ST1, the vehicle capability A11 decreases.

In the present embodiment, the degradation state DS1 (see FIG. 7B) of the battery can be calculated from the internal resistance value of the battery, for example. FIG. 7B shows the state DS11 where the battery is not degraded, the state DS12 where the battery is 10% degraded, and the state DS13 where the battery is 20% degraded. As shown in FIG. 7B, even at the same battery temperature T1, the vehicle capability A11 becomes lower as the degradation rate of the battery increases.

In the present embodiment, as shown FIG. 7C, the vehicle capability A11 is lower when the charge SOC 90 is higher. In one example in FIG. 7C, the vehicle capability A11 is constant when the charge SOC 90 is equal to or lower than the reference charge SOC 95, which is a reference. On the other hand, when the charge SOC 90 is higher than the reference charge SOC 95, the vehicle capability A11 is lower as the charge SOC 90 is higher than the reference charge SOC 95.

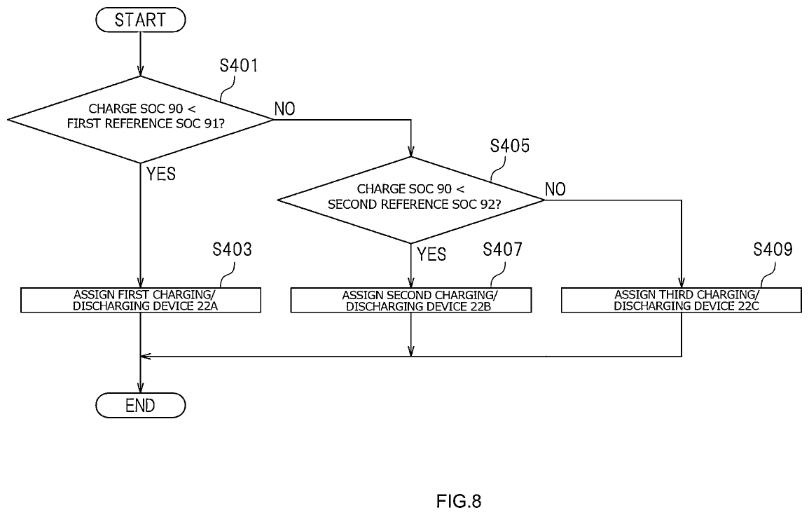

For example, the assigning controller 81 can assign the charging/discharging destination on the basis of the charge SOC 90 according to the flowchart of FIG. 8. As shown in FIG. 2, the storage 50 stores the first reference SOC 91 and the second reference SOC 92, for example. The first reference SOC 91 is lower than the second reference SOC 92. Here, in step S401 of FIG. 8, the state determination controller 77 of FIG. 2 determines whether or not the charge SOC 90 of the electric vehicle 10 is smaller than the predetermined first reference SOC 91. Here, if the state determination controller 77 determines that the charge SOC 90 is smaller than the first reference SOC 91, the process proceeds to step S403. In step S403, the assigning controller 81 of FIG. 2 assigns the first charging/discharging device 22A as a charging/discharging destination of the electric vehicle 10.

On the other hand, if the state determination controller 77 determines that the charge SOC 90 is equal to or higher than the first reference SOC 91 in step S401, the process proceeds to step S405. In step S405, the state determination controller 77 of FIG. 2 determines whether or not the charge SOC 90 of the electric vehicle 10 is smaller than the predetermined second reference SOC 92. If the state determination controller 77 determines that the charge SOC 90 is smaller than the second reference SOC 92, the process proceeds to step S407. In step S407, the assigning controller 81 of FIG. 2 assigns the second charging/discharging device 22B as a charging/discharging destination of the electric vehicle 10. On the other hand, if the state determination controller 77 determines that the charge SOC 90 is equal to or higher than the second reference SOC 92 in step S405, the process proceeds to step S409. In step S409, the assigning controller 81 of FIG. 2 assigns the third charging/discharging device 22C as a charging/discharging destination of the electric vehicle 10.

The charging/discharging device 22 as a charging/discharging destination is assigned to the electric vehicle 10 in this manner, and then, the presentation controller 83 of FIG. 2 presents the charging/discharging device 22 assigned by the assigning controller 81 to the user in step S109 of FIG. 3. The specific means of presenting the charging/discharging device 22 assigned by the assigning controller 81 to the user is not particularly limited. For example, the presentation controller 83 may indicate that the user can use the charging/discharging device 22 assigned by the assigning controller 81 on the screen 16 (see FIG. 2) of the user terminal 15. The presentation controller 83 may indicate the route to the charging/discharging device 22 assigned by the assigning controller 81 on the screen 16, or may provide directions to the charging/discharging device 22.

The user drives the electric vehicle 10 to the charging/discharging device 22 presented by the presentation controller 83. Thereafter, the electric vehicle 10 is connected to the charging/discharging device 22, so that the electric vehicle 10 can be charged/discharged.

As shown in FIG. 2, in the present embodiment, the charging/discharging management system 100 includes the first acquisition controller 61, the second acquisition controller 62, and the assigning controller 81. The first acquisition controller 61 is configured or programmed to acquire vehicle information A1 including the vehicle capabilities A11 (see FIG. 4) regarding charging/discharging capabilities (in other words, the charging/discharging rates) of multiple electric vehicles 10 as shown in step S103 of FIG. 3. The second acquisition controller 62 is configured or programmed to acquire device information A2 including device capabilities A21 (see FIG. 4) regarding charging/discharging capabilities (in other words charging/discharging rates) of the charging/discharging devices 22 capable of charging/discharging the electric vehicles 10 as shown in step S105 of FIG. 3. The assigning controller 81 is configured or programmed to compare the vehicle capabilities A11 and assign the charging/discharging device 22 having a high device capability A21 among the charging/discharging devices 22 for which device information A2 has been acquired in the second acquisition controller 62, to the electric vehicle 10 having a high vehicle capability A11. In this embodiment, the assigning controller 81 assigns the charging/discharging device 22 having a high device capability A21 to an electric vehicle 10 having a high vehicle capability A11. This allows a high vehicle capability A11 to be exhibited. Accordingly, the charging/discharging time for the electric vehicle 10 having a high vehicle capability A11 can be shortened.

In the present embodiment, the second acquisition controller 62 at least is configured or programmed to acquire the device information A2 of the first charging/discharging device 22A (see FIG. 4) and the device information A2 of the second charging/discharging device 22B (see FIG. 4) having a lower device capability A21 than the first charging/discharging device 22A. As shown in FIG. 2, the charging/discharging management system 100 includes the first communication controller 51 and the determination controller 71. As shown in step S101 of FIG. 3, the first communication controller 51 is configured or programmed to receive charging/discharging signals S1 which have transmitted from the users using the electric vehicles 10. As shown in FIG. 5, the determination controller 71 is configured or programmed to determine whether or not the vehicle capability A11 of each of the electric vehicles 10 used by the users who have transmitted the charging/discharging signals S1 is equal to or higher than the predetermined first reference ability SA11. The assigning controller 81 is configured or programmed to assign the first charging/discharging device 22A as a charging/discharging destination if the determination controller 71 determines that the vehicle capability A11 is equal to or higher than the first reference ability SA11, and assign the second charging/discharging device 22B as a charging/discharging destination if the determination controller 71 determines that the vehicle capability A11 is lower than the first reference ability SA11. The charging/discharging management system 100 further includes the presentation controller 83 (see FIG. 2) configured or programmed to present, to the user, the charging/discharging device 22 which has assigned by the assigning controller 81 as shown in step S109 of FIG. 3. This allows the first charging/discharging device 22A having a relatively high device capability A21 to be assigned if the vehicle capability A11 is equal to or higher than the first reference ability SA11. Further, the user can easily see which of the charging/discharging devices 22 can be used to shorten the charging/discharging time by looking at the charging/discharging device 22.

In this embodiment, the first communication controller 51 is configured or programmed to receive the charging/discharging signals S1 which have transmitted from the users using the electric vehicles 10 during the predetermined period of time. The assigning controller 81 is configured or programmed to assign the charging/discharging devices 22 to the respective electric vehicles 10 so that a difference of the vehicle capability A11 of each of the electric vehicles 10 from the device capability A21 becomes small. This allows the assignment of the charging/discharging device 22 having a device capability A21 that is close to the vehicle capability A11 of each of the electric vehicles 10.

In the present embodiment, the charging/discharging management system 100 includes, as shown in FIG. 6, the calculation controller 73 (see FIG. 2) configured or programmed to calculate the first distance D11 from the electric vehicle 10 to the first charging/discharging device 22A and the distance determination controller 75 (see FIG. 2) configured or programmed to determine whether or not the first distance D11 calculated by the calculation controller 73 is shorter than the predetermined reference distance SD1. If the determination controller 71 determines that the vehicle capability A11 is equal to or higher than the first reference ability SA11, and the distance determination controller 75 determines that the first distance D11 is shorter than the reference distance SD1, the assigning controller 81 of FIG. 2 is configured or programmed to assign the first charging/discharging device 22A as a charging/discharging destination. For example, if the distance to the charging/discharging device 22 as the charging/discharging destination is long, it will take time to reach the charging/discharging device 22. Therefore, in this embodiment, the charging/discharging device 22 with a shorter distance D1 than the reference distance SD1 is a candidate of the charging/discharging destination. Accordingly, time to reach the charging/discharging device 22 can be shorten while shortening the charging/discharging time.

In the present embodiment, the vehicle information A1 which has acquired by the first acquisition controller 61 includes battery states of the batteries mounted on the electric vehicles 10. The assigning controller 81 is configured or programmed to assign the charging/discharging device 22 to the electric vehicle 10 on the basis of the battery states. The vehicle capability A11 can be calculated according to the battery states of the electric vehicles 10. Thus, the charging/discharging time can be shortened by assigning the charging/discharging device 22 to the electric vehicle 10 on the basis of the battery states.

In the present embodiment, the battery state includes at least the charge SOC 90 shown in FIG. 7C. As shown in FIG. 8, the charging/discharging management system 100 includes the state determination controller 77 (see FIG. 2) configured or programmed to determine whether or not the charge SOC 90 is smaller than the predetermined first reference SOC 91. If the state determination controller 77 determines that the charge SOC 90 is smaller than the first reference SOC 91, the assigning controller 81 of FIG. 2 is configured or programmed to assign the first charging/discharging device 22A. Here, as shown in FIG. 7C, if the charge SOC 90 is excessively high, the vehicle capability A11 becomes low. Thus, if the charge SOC 90 is smaller than the first reference SOC 91, the first charging/discharging device 22A having a relatively high device capability A21 is assigned.

In the present embodiment, each of the vehicle capability A11 and the device capability A21 is a charging/discharging rate. Thus, when the vehicle capability A11 is high, the charging/discharging rate becomes high, and when the device capability A21 is high, the charging/discharging rate becomes high. Accordingly, the charging/discharging time can be shortened by assigning the charging/discharging device 22 having a high device capability A21 to the electric vehicle 10 having a high vehicle capability A11.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A charging/discharging management system comprising:
a first acquisition controller configured or programmed to acquire vehicle information including vehicle capabilities regarding charging/discharging capabilities of multiple electric vehicles;
a second acquisition controller configured or programmed to acquire device information including device capabilities regarding charging/discharging capabilities of multiple charging/discharging devices capable of charging/discharging the electric vehicles; and
an assigning controller is configured or programmed to compare the vehicle capabilities and assign the charging/discharging device having a high device capability among the charging/discharging devices for which the device information has been acquired in the second acquisition controller, to the electric vehicle having a high vehicle capability.

2. The charging/discharging management system according to claim 1, wherein
the second acquisition controller at least is configured or programmed to acquire the device information of a first charging/discharging device and the device information of a second charging/discharging device having a lower device capability than the first charging/discharging device,
the charging/discharging management system further comprises:
a communication controller configured or programmed to receive charging/discharging signals which have been transmitted by users using the electric vehicles; and
a determination controller configured or programmed to determine whether or not the vehicle capabilities of the electric vehicles used by the users who have transmitted the charging/discharging signals are equal to or higher than a predetermined reference capability,
the assigning controller is configured or programmed to assign the first charging/discharging device as a charging/discharging destination if the determination controller determines that the vehicle capability of the electric vehicle is equal to or higher than the reference ability, and assign the second charging/discharging device as a charging/discharging destination if the determination controller determines that the vehicle capability of the electric vehicle is lower than the reference ability, and
the charging/discharging management system further comprises:
a presentation controller configured or programmed to present, to the user, the charging/discharging device which has been assigned by the assigning controller.

3. The charging/discharging management system according to claim 2, wherein
the communication controller is configured or programmed to receive the charging/discharging signals which have been transmitted by the users using the electric vehicles during a predetermined period of time, and
the assigning controller is configured or programmed to assign the charging/discharging devices to the respective electric vehicles so that differences of the vehicle capabilities of the electric vehicles from the device capabilities become small.

4. The charging/discharging management system according to claim 3, further comprising:
a calculation controller configured or programmed to calculate a distance from the electric vehicles to the first charging/discharging device; and
a distance determination controller configured or programmed to determine whether or not the distance calculated by the calculation controller is shorter than a predetermined reference distance, wherein
the assigning controller is configured or programmed to assign the first charging/discharging device as a charging/discharging destination if the determination controller determines that the vehicle capability of the electric vehicle is equal to or higher than the reference ability, and the distance determination controller determines that the distance is shorter than the reference distance.

5. The charging/discharging management system according to claim 2, wherein
the vehicle information acquired by the first acquisition controller includes battery states of batteries mounted on the electric vehicles, and
the assigning controller is configured or programmed to assign the charging/discharging devices to the respective electric vehicles on the basis of the battery states.

6. The charging/discharging management system according to claim 5, wherein
each of the battery states includes at least charge SOC,
the charging/discharging management system further comprises: a state determination controller configured or programmed to determine whether or not the charge SOC is smaller than a predetermined reference SOC, and
the assigning controller is configured or programmed to assign the first charging/discharging device if the state determination controller determines that the charge SOC is smaller than the reference SOC.

7. The charging/discharging management system according to claim 1, wherein
each of the vehicle capabilities and the device capabilities is a charging/discharging rate.
